(19) United States
(12) Patent Application Publication
(10) Pub. No.: US 2005/0045674 A1
(43) Pub. Date: Mar. 3, 2005

(54) Baby carrier with enclosure system

(76) Inventor: Jurg Rehbein, New York, NY (US)

Correspondence Address: JONES DAY, 222 EAST 41ST ST, NEW YORK, NY, 10017, US

(21) Appl. No.: 10/926,740

(22) Filed: Aug. 25, 2004

Related U.S. Application Data
(60) Provisional application No. 60/497,723, filed on Aug. 25, 2003.

(51) Int. Cl. A61G 1/00; A47G 9/00; A47C 31/10

(52) U.S. Cl. 224/160

(57) ABSTRACT

A baby carrier with an enclosure system to be worn on the chest of an adult is disclosed. The carrier ensures safety by allowing for the easy attachment and removal of a cover blanket while leaving the baby in the soft seat of the carrier. The carrier consists of a body blanket, a harness, a soft seat, and a cover blanket. The body blanket is a garment that runs between the adult's body and the baby. The harness consists of the waist belt and shoulder straps and is attached to the side of the body blanket facing the adult. The soft seat is attached to the side of the body blanket facing the baby. The cover blanket is a garment that when attached to the body blanket will surround not only the soft seat of the baby carrier but the entire infant including the arms and legs that are usually exposed in baby carriers. To form such an enclosure the cover blanket is connected to the body blanket along the bottom edge and along the two edges running along both sides. The cover blanket may be attached to the body blanket with zippers, snaps or any other attachment. Temperature inside the covering bag may be adjusted by partially closing two-way zippers, which also allow for easy access to the child for the adult. An integral or removable hood may be provided which can be attached in two ways to enable the baby to face toward or away from the adult. There may also be two holes or a slot on the bottom of the body blanket and the cover blanket to allow for their attachment to strollers or car seats when the waist belt and shoulder straps are removed from the body blanket.

### CROSS-REFERENCE TO RELATED APPLICATIONS

This application claims priority to provisional patent application Ser. No. 60/497,723, filed Aug. 25, 2003, entitled Covering Bag for Baby Carriers, which is hereby incorporated by reference for each of its teachings and embodiments.

### BACKGROUND OF THE INVENTION

The present invention relates generally to the field of baby carriers. More specifically, the present invention relates to a baby carrier worn on the chest side of the body with an enclosure system. The baby carrier consists of four detachable parts: a body blanket, a cover blanket, a harness and a soft seat. The body blanket runs between the adult's body and the baby. The cover blanket attaches to the body blanket forming an enclosure. The harness consists of a waist belt and shoulder straps and is worn by the adult. The soft seat holds the baby and attaches to the harness directly or to the body blanket.

The body blanket forms a comfortable surface for the baby to rest on, protecting the baby from zippers, buttons or necklaces that the adult may be wearing. The body blanket also preserves the adult's clothing from the baby's drooling. The body blanket can function in two ways: it can act as a hub between the harness and the soft seat whereby the harness is connected to the side of the body blanket facing the adult and the soft seat is connected to the side of the body blanket facing the baby, or the body blanket can have an opening through which the harness can be attached straight to the soft seat.

The cover blanket can be attached to the body blanket to form a baglike enclosure, protecting an infant or baby from the elements. The cover blanket is attached to the body blanket at its outside edges running from the baby's shoulder to below its feet and at the bottom edge that connects the sides. The cover blanket is safe to use because it does not interfere with the handling of the soft seat nor the waist belt and shoulder straps of the harness or, in other words, it can be put on and removed easily without removing the baby from the soft seat. This new carrier alleviates the need for layers of clothing and makes it easy to move between indoors and outdoors. A baby's extremities are not exposed in this baby carrier with its enclosure system. This baby carrier, while protective, still leaves the baby ample space to move their arms and legs. It can feature two-way zippers along its edges that open partially from the bottom to control overheating, also allowing the adult to tend to the baby without taking the cover blanket off.

An integral or removable hood can protect the baby's sensitive head from the weather. The removable hood may be attached in two ways allowing the baby to face toward or away from the adult.

A slot or a hole may be provided between the legs of the baby which allows for the use of a three or five belt seat belt arrangement. This makes this baby carrier with its enclosure system even more versatile allowing its use on strollers and car seats. The extended use of this carrier with these openings is useful because many adults that use baby carriers worn on the body are using strollers and car seats as well.

A practical baby carrier worn on the chest-side of the body with the above-mentioned features is not disclosed in the art. The present baby carrier with its integral enclosure system is safe and protects a baby from the elements.

Existing baby carriers worn on the chest side of the body are constructed in a manner where the adult's harness with the waist belt and shoulder straps is directly attached to the baby's soft seat. This provides a difficulty for existing buntings or covers to attach to such carriers because the harness would always encumber a sufficient enclosure allowing for big gaps through which cold air and wetness could enter. Also the baby's head and arms would rest on the adults clothing which can contain buttons, zippers or jewelry that can scratch the baby.

This present invention consists of four basic detachable parts: (a) a body blanket that runs between the adult's body and the baby, (b) removable cover blanket that doesn't interfere with the harness or soft seat, (c) the harness consisting of the waist belt and shoulder straps that are attached to the side of the body blanket facing the baby, and (d) the soft seat that is attached to the body blanket.

The body blanket forms the hub that links the body harness and the baby's soft seat and also allows for the attachment of the cover blanket. This construction with a central body blanket has several advantages. First, this new baby carrier with its own removable cover blanket eliminates the need to attach foreign, not as efficient buntings. The construction can eliminate the need to leave gaps in the enclosure for the harness or keeps the opening at a minimal size. This allows the baby to be enclosed and fully protected from cold and wet weather. It also forms a comfortable surface for the baby to rest on, protecting the baby form zippers, buttons or necklaces that the adult might be wearing. While it also protects the adults clothing, if necessary, from the baby's drooling.

It also makes the cover blanket safe to use with this baby carrier because it does not interfere with the handling of the carrier's soft seat nor the waist belt and shoulder straps. It can therefore be put on and removed easily without removing the baby from the soft seat.

No existing baby carriers are designed with a body blanket that forms a structural link between the body harness of the adult and the soft seat for the baby.

The functionality of first fully enclosing a baby when a cover blanket is attached to the body blanket, and second being able to remove and add this cover blanket while leaving the baby attached to the adult in its soft seat is not present in the art.

Baby covers and buntings are in general designed to care for the health and well being of a baby by protecting them from the elements. Existing baby carriers worn on the chest side of the body are attached to the adults body with a waist belt and at least one shoulder strap. Existing baby covers blankets or buntings aren't useful because they can't get around all the straps of the harness and the soft seat. Therefore to keep babies warm and they had to be dressed in layers of clothing which made it cumbersome to get the baby into the carrier and time consuming to undress and dress the baby when changing between indoors and outdoors.

Some baby covers are designed to attach to the outside of a baby carrier by attaching to the shoulder straps or the soft seat. The disadvantage of such existing buntings is that they because of the harness only very partially are enclosing the baby letting cold air still get to the baby. This is because existing buntings only consist of a cover blanket and not of an enclosure system as described in this invention, which provides a body blanket conceived to accept the cover blanket.

There are no existing baby carriers worn on the chest side of the body that are conceived to form a continuous baglike enclosure when a cover blanket is attached to a body blanket.

U.S. Pat. No. 6,055,686 issued to Knight shows a bunting that is designed only to protect a child in a rigid seat such as a car seat or stroller seat and is not suitable for baby carriers worn on the chest side of the adult. This bunting is more like a sleeping bag that can held in place by a shoulder harness. It describes in no way how a baby in a soft seat with a harness can be surrounded by it.

US. Pat. No. 6,272,683 B 1 issued to Symms et al. shows the same shortcomings as the above-described bunting by Knight.

U.S. Pat. No. 4,241,458 issued to Lesesne shows another bunting that attaches to a seat with the same shortcoming as described above.

US. Pat. No. 5,611,095 by Schneider shows a bunting that wraps around the legs of a baby and then fits inside but not enclosing a baby carrier worn on the body. The Bunting in Schneider acts as an extra layer of clothing, and not as an enclosure system that encloses the whole soft seat of the baby carrier worn on the body.

In view of the above-mentioned shortcomings of known buntings, the new features of the present invention fulfill a need: they protects babies or infants from the elements by enclosing the baby thoroughly but also enable the adults to easily remove or attach the cover blanket. The present invention also makes the transition between indoor and outdoor spaces easy. The baby is also able to straddle its feet because of the non-confining nature of the enclosure. The baby, as in a carrier without enclosures, can still face away or towards the adult because of the hood being attachable to either the body blanket or the cover blanket.

### SUMMARY OF THE INVENTION

It is an object of the present invention to provide a new baby carrier or child supporting harness worn on the chest side of the body with an integral enclosure system. The enclosure system consists of a body blanket, a cover blanket, a harness, and a soft seat.

The body blanket, is a garment that forms a comfortable surface for the baby to rest on, protecting the baby from zippers, buttons or necklaces that the adult might be wearing and in return as well protects the adults clothing, if necessary, from the baby's drooling. The body blanket forms the hub that links the body harness of the adult to the baby's soft seat and also receives the cover blanket.

Another object of the present invention is to provide a new baby carrier with the integral body blanket, the first garment, that has a removable cover blanket, a second garment that when attached to the body blanket form a continuous, baglike enclosure. This cover blanket doesn't need to leave any gaps for the adult's harness or the baby's soft seat because it does not interfere with them. This allows the baby to be fully enclosed and fully protected from cold and wet weather. The baby's body as well as the extremities that are most exposed in a baby carrier are staying warm. At the same time this enclosure formed by the body blanket and cover blanket is large enough so that the movement of the infant's legs and arms isn't restricted.

It is another object of the present invention to provide a new baby carrier that can be enclosed and opened with the cover blanket while leaving the baby in the carrier.

It is another object of this invention for the cover blanket to be safe to use with this baby carrier because it does not interfere with the handling of the carrier's soft seat nor the waist belt and shoulder straps. It can be put on and removed easily without removing the baby from the soft seat.

It is another object of this invention to provide temperature control by installing two-way zippers along the edges that can be opened partially to control the exchange of temperature between the inside and the outside. The two-way zippers allow also the adult to tend to the infant's needs while keeping the cover blanket attached.

It is another object of this invention to provide two positions for the baby while in its protective enclosure; one facing towards the wearer or another to look out away from the wearer. In the first position the cover blanket fits snug against the soft seat while in the second position space has to be left between the soft seat and the cover blanket for the baby's arms which can also extend over the top edge of the soft seat. These positions can ask for extra attachment locations between the cover blanket and the soft seat.

It is another object of the invention to protect the baby's head from the elements by means of a hood. The hood can be attached permanently or removable to the top edge of the body blanket so that the baby can face away from the wearer or it can be attached to the top edge of the cover blanket, so that the baby can face to the wearer.

It is also an object of the invention to provide a safe hood which will not collapse into the baby's face and interfere with the baby's breathing.

It is another object of this invention to provide that the baby carrier with all the aforementioned features can also be used on strollers or car seats. The harness and the soft seat would not need to be installed on the body blanket rendering the baglike enclosure to be simply used as a bag. For this embodiment of the invention the bag will have a slot that runs up from the center of the bottom edge to the point where the soft seat is attached. Instead of the slot it may have two corresponding holes, one in the body blanket and the other in cover blanket. The location of the holes would be right below the attachment of the soft seat. The slot or the holes allow for the insertion of a strap between the legs of the baby from a three or five belt seat belt arrangement used on strollers and car seats.

This new baby carrier is manufactured from readily available materials, which are made through conventional manufacturing processes and suitable to surround babies. The materials chosen depend on the intended use. For example, in cold weather the cover blanket may be nylon or Gore Tex with a fleece lining. For rainy days a cover blanket made solely from nylon might be preferable. And for outdoor trips in the fall, a cover blanket made from fleece alone might be suitable. This is not an exhaustive list and it would be obvious to one skilled in the art that other materials may be suitable for the present invention.

In view of the aforementioned considerations there is a need for a baby carrier worn on the chest side of the wearer with a integral enclosure system that can be conveniently taken off and put on facilitating the movement between the indoors and outdoors.

In one embodiment, the invention comprises a baby carrier comprising a harness to connect to a person, a soft seat to hold a baby, a first garment that fits between the baby and the person, and a second garment that connects to the first garment around the soft seat on a side facing away from the person, wherein the first and second garments form an enclosure surrounding the baby with the soft seat.

In another embodiment, the harness is configured and adapted to attach the baby carrier to the chest of the person.

In another embodiment, the baby carrier further comprises an attachment mechanism that removably accepts the harness on the side of the first garment that faces the wearer.

In another embodiment, the baby carrier further comprises an attachment mechanism that removably accepts the soft seat on the side of the first garment facing the baby.

In another embodiment, the baby carrier further comprises a permanently attached soft seat on the side of the first garment facing the baby.

In another embodiment, the enclosure has two edges along each side from the baby's shoulders to below its feet and a bottom edge that runs below the baby's feet connecting the two sides whereby the first and second garment meet at these edges.

In another embodiment, the first and second garments are attached along the sides and along the bottom edge. These garments may be attached using a zipper, buttons, or Velcro.

In another embodiment, the first and second garments may be opened slightly to allow for temperature control.

In another embodiment, the attachment mechanism on the first garment can be tugged away along its edges.

In another embodiment, the first garment has a top edge that extends above the face of the baby in order to protect the person's clothes.

In another embodiment, the first garment has a top edge that extends above the face of the baby in order to protect the baby from anything sharp or rough on the parents clothing.

In another embodiment, the top edge of the second garment is attached to the top edge of the soft seat.

In another embodiment, the baby carrier further comprises a hood that covers the baby's head and is attached to the first garment wherein the hood faces away from the person. The hood may face toward or away from the person. The hood may also be removable. The hood may also be reinforced to hold a shape.

In another embodiment, the first and second garments are permanently attached along the bottom edge.

In another embodiment, the second garment can be tugged away.

In another embodiment, the same attachment mechanism is used for connecting the soft seat to the first garment on one side as is for the harness on the other side of the first garment. The soft seat may be adapted to allow for it to be tugged away.

In another embodiment, the first garment has one opening that allows one fastener of the harness to connect directly to the bottom of the soft seat.

In another embodiment, the first garment has a plurality of openings that allow for all the fasteners of the harness to connect directly to all of the fasteners of the soft seat. One or more of these openings may have an elastic edge that closes tightly around the harness. Alternately, the opening may have a mechanism that allows it to open and close around the harness. In one embodiment, this mechanism may be a draw string with a stopper.

In another embodiment, the second garment has a strap that passes laterally between the chest of the person and the harness to connect the two top corners of the second garment.

In one embodiment, the enclosure has a slot coming up from the center of the bottom edge that extends to just below the soft seat to allow for attachment of the enclosure to a stroller or car seat.

In one embodiment, the first and second garments have a plurality of openings to allow the passing through of seat belts.

In one embodiment, the second garment further comprises a pouch.

An alternate embodiment the baby carrier comprises a harness to connect to a person, a soft seat connected to the harness to hold a baby, a body blanket connected to the soft seat that fits between the baby and the person, and a cover blanket connected to the body blanket, wherein the cover blanket and the body blanket form an enclosure. This baby carrier may comprise a hood that covers the baby's head. The hood may be reinforced.

### BRIEF DESCRIPTION OF THE DRAWINGS

FIG. 1 shows a person wearing the baby carrier with the cover blanket only attached with two way zippers along the bottom edge and the soft seat permanently attached to the body blanket.

FIG. 2 shows the baby carrier of FIG. 1 with a baby in the soft seat.

FIG. 3 shows a person wearing the baby carrier with a cover blanket and no hood with the baby facing the wearer.

FIG. 4 shows a person with the baby in the carrier with removable hood attached to the cover blanket and the baby facing the wearer.

FIG. 5 shows a person wearing the baby carrier with a cover blanket that has a removable hood and the baby faces outward, away from the wearer.

FIG. 6 shows a plan view of the baby carrier with the body and cover blanket detached and a removable soft seat.

FIG. 7 shows the back of the body blanket to which the harness is attached.

FIG. 8 shows one embodiment of a harness.

FIG. 9 shows the body blanket with Velcro strips that allow for the tugging away of the zippers.

FIG. 10 shows the body blanket of FIG. 9 with the zippers tugged away.

FIG. 11 shows a person wearing the baby carrier with the cover blanket permanently attached to the body blanket along the bottom edge.

FIG. 12 shows the baby carrier of FIG. 11 with the cover blanket rolled up.

FIG. 13 shows a person wearing the baby carrier with a slot between the baby legs.

FIG. 14 is a perspective view of the baby carrier of FIG. 13.

FIG. 15 shows a plan view of the open baby carrier with the body and cover blanket permanently attached and two holes to feed car seat harness through.

FIG. 16 shows the baby carrier of FIG. 15 in its closed position showing the hole on the cover blanket with a flap.

FIG. 17 shows another embodiment of a harness.

FIG. 18 shows the back of the body blanket to which the harness of FIG. 17 is attached.

FIG. 19 shows a person wearing a baby carrier whereby the body blanket has two slots.

FIG. 20 shows the back of the body blanket of the baby carrier of FIG. 19.

FIG. 21 shows a person wearing a baby carrier whereby the body blanket has four slots and is removable.

FIG. 22 shows the back of the body blanket of the baby carrier featured in FIG. 21.

FIG. 23 shows a person wearing a baby carrier whereby a removable body blanket has one large opening for the harness to pass through and attach to the soft seat.

FIG. 24 shows the baby carrier of FIG. 23 with a baby in the soft seat.

FIG. 25 shows a removable body blanket whereby the cover blanket attaches to the harness with a removable hood not attached.

FIG. 26 shows the blanket of FIG. 25 with the removable hood attached.

FIG. 27 shows a baby carrier with an expandable opening for the harness to pass through in its pulled together position.

FIG. 28 shows the baby carrier of FIG. 27 in its expanded position.

FIG. 29 shows a baby carrier with an opening for the harness to pass through whereby the opening has an elastic band in its seam with two stops in its relaxed position.

FIG. 30 shows the baby carrier of FIG. 29 in its contracted position.

FIG. 31 shows a detail of the same baby carrier as in FIG. 29 with extra fabric for the expanded position.

FIG. 32 shows a detail of the baby carrier of FIG. 29 in its contracted position.

FIG. 33 shows a plan view of the removable hood with a stiff band sewn in its edge to prevent the hood from falling in the baby's face.

FIG. 35 shows a plan view of removable hood with a stiff mesh sewn in to prevent the hood from falling in the baby's face.

FIG. 36 is a perspective view of the hood of FIG. 35.

FIG. 37 shows a plan view of removable hood with a stiff mesh sewn in and a zipper allowing the opening of the hood.

FIG. 38 shows a perspective view of the same hood as in FIG. 37 with the hood closed.

FIG. 39 shows a plan view of the same hood as in FIG. 37. With the hood folded down.

FIG. 40 shows a perspective view of the same hood as in FIG. 37 with the hood folded down.

FIG. 41 shows a perspective view of a removable hood with a band to protect the baby's face in its open position.

FIG. 42 shows a perspective view of the hood of FIG. 41 with the band closed.

FIG. 43 shows a perspective view of a removable hood with a face shield with an expandable opening.

FIG. 44 shows the same hood as in FIG. 43 attached to a baby carrier with the baby facing away from the adult.

### DETAILED DESCRIPTION OF THE PREFERRED EMBODIMENTS

Turning now to the drawings, whereby the baby carrier is seen to comprise of a body blanket generally designated with the reference numeral 1, a cover blanket 2, a soft seat 3, a harness made up from shoulder straps 4 and a waist belt 5 and a hood 6.

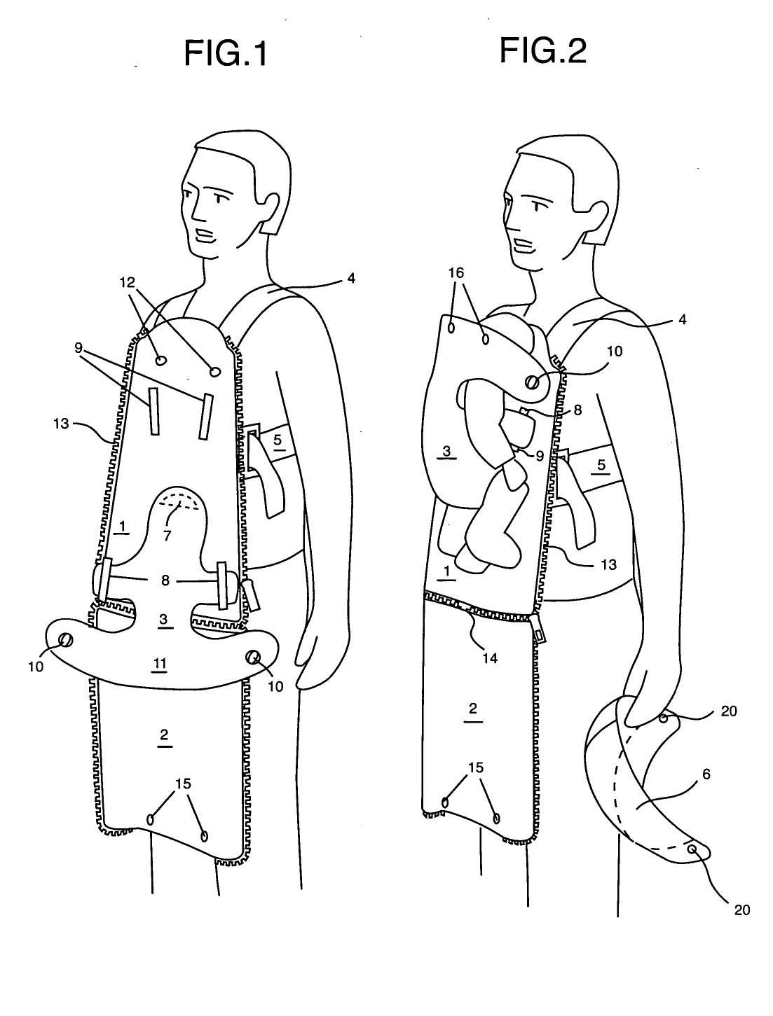

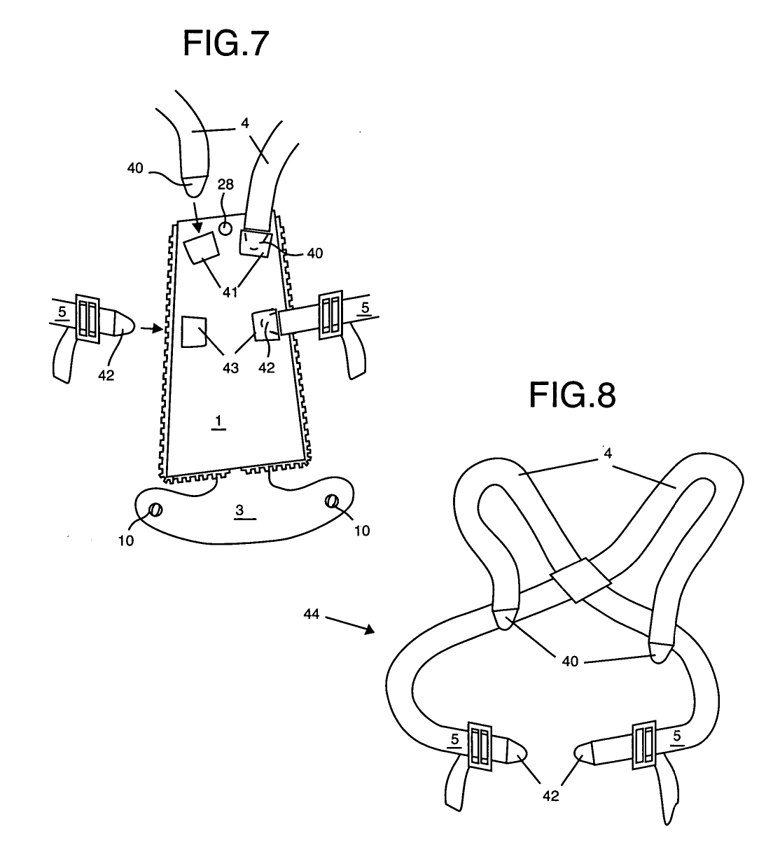

The body blanket 1 that runs between the adult's body and the baby is the centerpiece or hub of this carrier. The soft seat 3 is attached to the side of the body blanket 1 facing the baby as seen in FIG. 1 and FIG. 2 while the waist belt 5 and shoulder straps 4 are attached to the body blanket 1 facing the adult as seen in FIG. 7. As shown in FIG. 1 the soft seat can be attached to the body blanket 1 fixedly at a point 7 or it can be attached removable, as shown in FIG. 6. The baby is secured in the soft seat 3 when it is attached to the body blanket 1 by means of two clasps 8 that hook into two receptacles 9. Further securing the baby to the body blanket 1 are two fasteners 10 on each side of the neck rest 11 of the soft seat 3 that attach to two corresponding receptacles 12 on the body blanket 1. The fasteners 10 can also be mounted on a strap to give the baby seat more expandability. Any other attachment mechanism of the soft seat 3 to the body blanket 1 can be employed without changing the spirit of the invention.

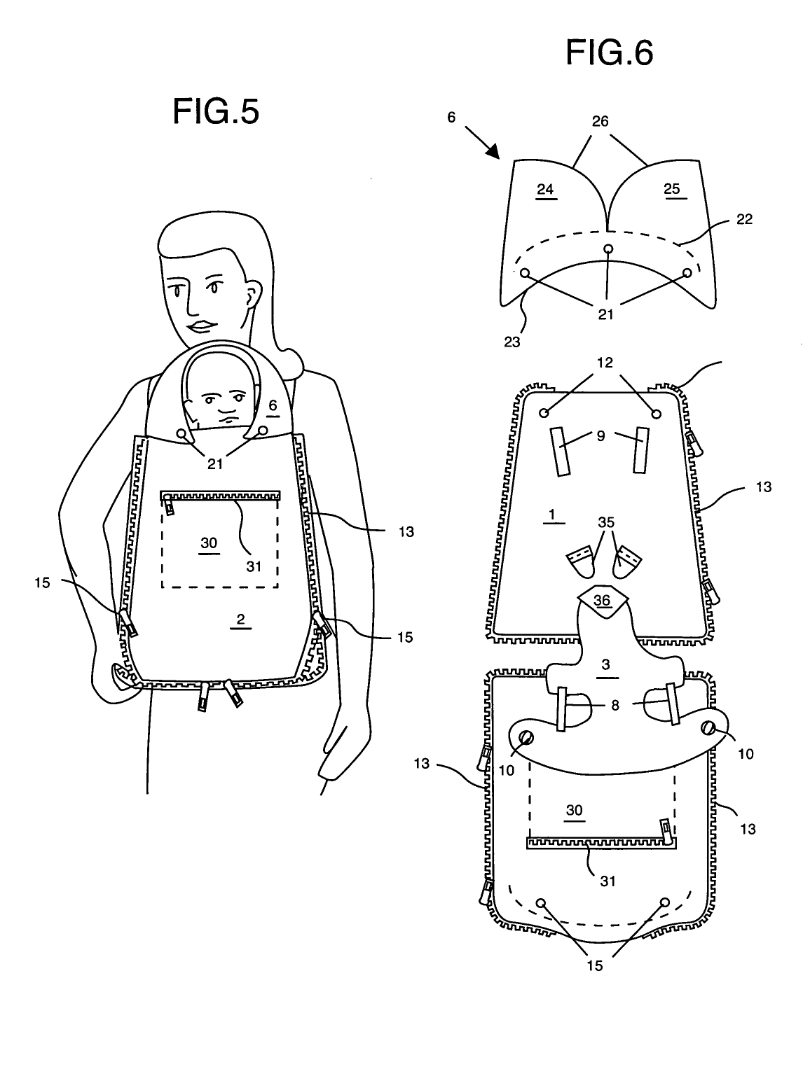

The cover blanket 2 is safe to use because it does not interfere with the handling of the carrier's soft seat 3 nor the waist belt 5 or the shoulder straps 4. As shown in FIG. 1 through FIG. 3, it can be put on and removed easily without removing the baby from the soft seat 3. The body blanket 1 and cover blanket 2 are connected by means of a zipper, in this embodiment a pair of two-way zippers 13. They meet at the center 14 of the bottom edge, allowing for the baglike enclosure; formed by the body blanket 1 and the cover blanket 2, to be opened partially with the second tabs 15 as shown in FIG. 4 and FIG. 5. With the two-way zippers 13 the baby carrier features temperature control by allowing the exchange of air between the inside and the outside of the enclosure. They also allow for access of the adult or guardian to tend to the infant's needs while keeping the cover blanket 2 attached as seen in FIG. 4 and FIG. 5. Other attachment methods such as snaps could perform the same function as the two-way zippers 13 without changing the spirit of the invention.

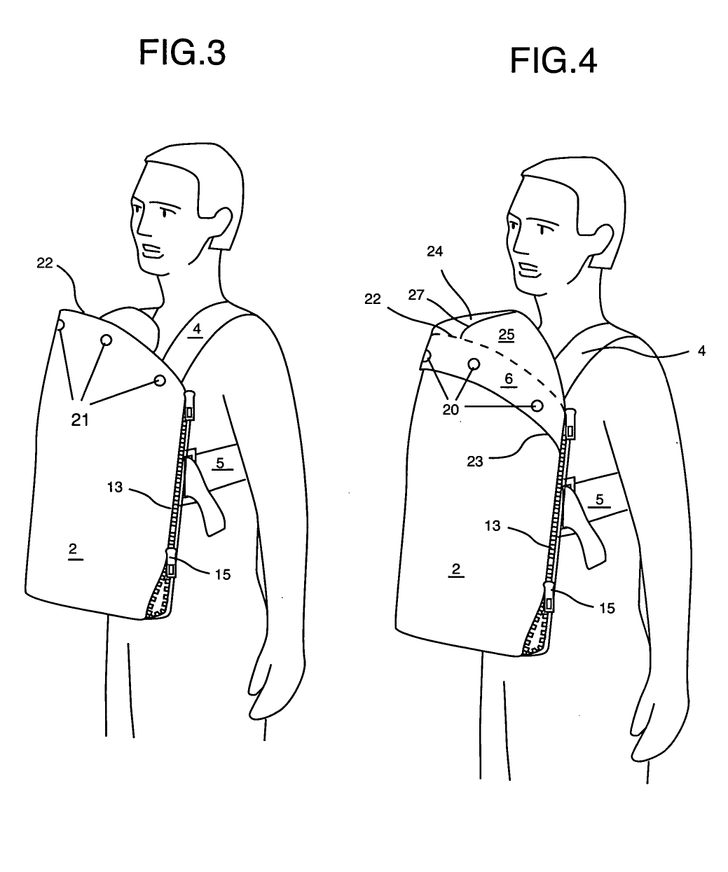

As seen in FIG. 1 and FIG. 2 there are two snaps 15 that attach to two corresponding receptacles 16 on the outside of the neck rest 11, which keep the cover blanket 2 from slipping down. In the position facing towards the wearer as seen in FIG. 3 and FIG. 4 the cover blanket fits snug against the soft seat. In the position looking out away from the wearer as shown in FIG. 7 space has to be left between the soft seat 3 and the cover blanket 2 for the baby's arms which extend over the top edge of the soft seat 3. These positions may require extra attachment locations between the cover blanket and the soft seat.

A hood 6, in this embodiment removable, can be attached with three snaps 20 to three corresponding receptacles 21 on the outside of the cover blanket 2 as seen in FIG. 3 and FIG. 4 allowing the baby to wear the hood 6 while facing the adult as shown in FIG. 4. The same hood can also be attached to three receptacles 22 on the inside of the body blanket 1 as seen in FIG. 7 allowing the baby to wear the hood 6 and face out as shown in FIG. 5. The plan view of FIG. 7 shows in more detail the making of a removable hood 6. Its cutting pattern consists of two halves 24 and 25 which when sewn together at the edges 26 will for the seam 27 as shown in FIG. 4. For warmth and insulation from the wet the hood 6 overlaps the cover blanket's 2 upper edge 22.

FIG. 5 also shows a storage bag 30 sewn into the inside of the cover blanket 2. If the baby carrier has a lining this bag 30 will be between the cover blanket's 2 outer fabric and its lining and therefore not encumber the baby in any way. The storage bag can have a zipper 31 that allows it to be closed. Diapers, pacifiers etc. can be stored in this bag, which can eliminate the need for the adult to bring handbag and free up their hands.

FIG. 6 also shows a removable attachment method, in this case a clasp, of the soft seat 3 to the body blanket 1. This clasp consists of a receptacle 36 sewn to the bottom of the soft seat 3 and two inserts 35 sewn onto the body blanket 1 at about waist level. Any other removable mechanism could be used without changing the spirit of the invention.

FIG. 7 shows the side of the body blanket 1 that faces the adult with clasps that allow for the attachment of a harness 44 as shown in FIG. 8. In this embodiment the shoulder straps 4 are attached by the inserting ends 40 of the clasps to the receiving parts 41 located at the top of the body blanket 1. The waist belt 5 is attached in the same method whereby the parts 42 are inserted into the receiving parts 43 of the clasp located at the waist level of the body blanket 1. FIG. 8 shows the whole harness 44 with the inserts 40 and 42 respectively at the end of the shoulder strap 4 and the waist belt 5.

Reviewing FIG. 6 through 8 it becomes clear how the body blanket 1 can perform its function of a hub between the harness 44 and the soft seat 3. It shows also how the cover blanket 2 does in no way interfere with attachment of the harness 44 nor the baby seat 3.

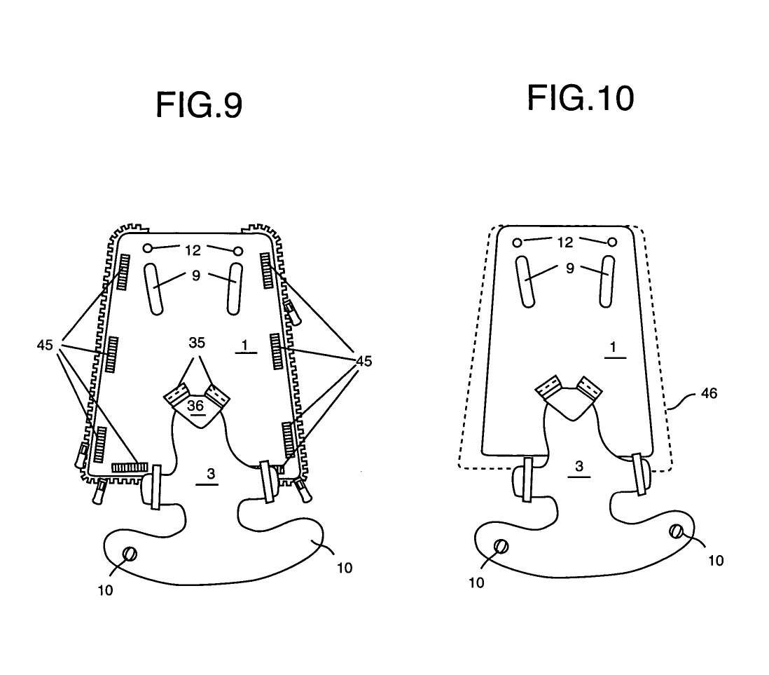

FIG. 9 shows the body blanket 1 with Velcro strips 45 that allow for the tugging away of the zippers 13 by rolling up the edges of the body blanket 1. FIG. 10 shows the same body blanket as in FIG. 9 with the zippers tugged away with a dotted outline of the body blanket 1 with the zipper 13. This is useful when the seasons change and there is not as much of a use for the cover blanket 2. The cover blanket 2 is still easily accessible especially in summer in case of rain where a rain cover blanket 2 only made of thin nylon comes in handy.

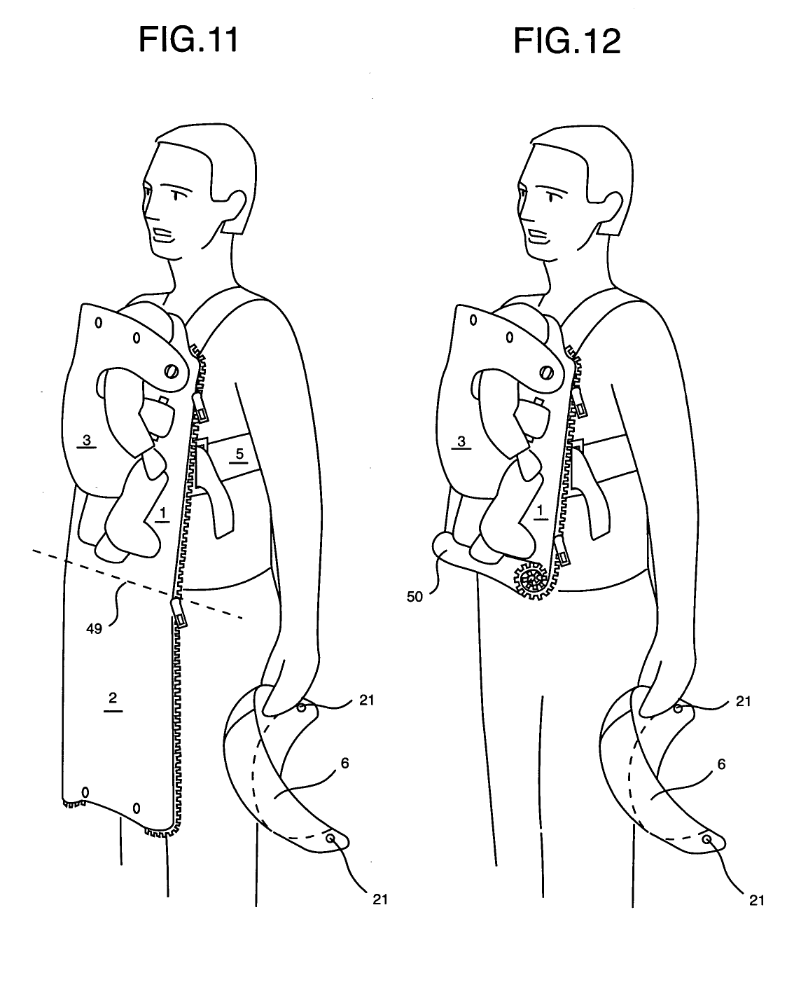

FIG. 11 shows a person wearing the baby carrier with the cover blanket 2 permanently attached to the body blanket 1 along the bottom edge 49 of the baby carrier. This can be of advantage in long cold seasons of certain climates. The adult can save time by not having to remove or install the cover blanket 2 at all. FIG. 12 shows the cover blanket 2 rolled into a tube 50 which leaves the cover blanket 2 handy but also tugged away.

The roll 50 can be kept in place by straps with snaps, tug away bags or any of several methods familiar to anybody in the garment manufacturing trade.

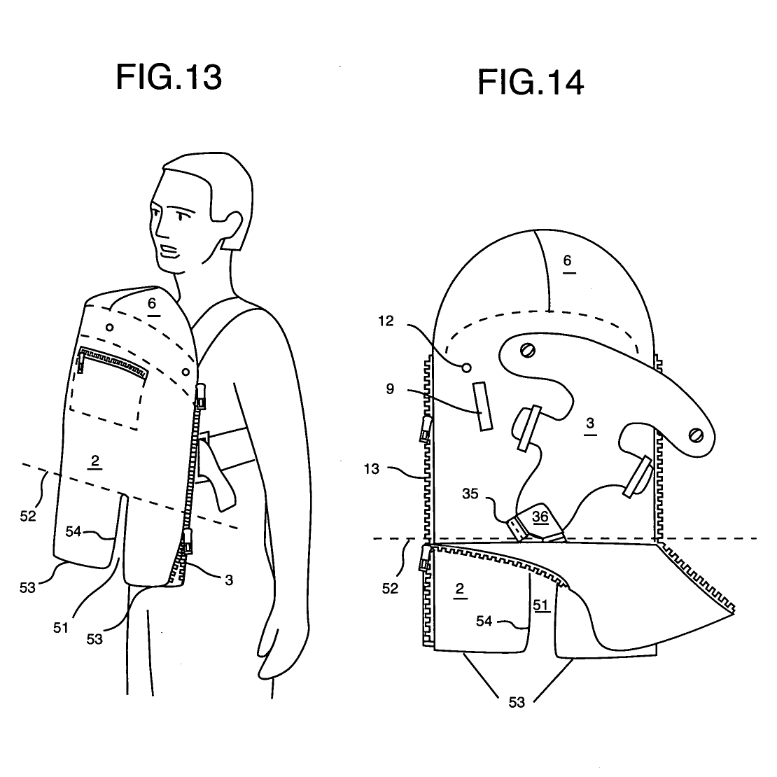

FIG. 13 shows the baby carrier with a slot 51 between the baby legs. The slot 51 comes up to a level 52 just below the attachment of the soft seat 3 as visible in FIG. 14. The body blanket 1 and the cover blanket 2 are sewn together along the slot's edge 54 and the bottom edge 53 of the baby carrier. With the soft seat 3 and the harness 44 are detached the enclosure formed by the body blanket 1 and the cover blanket 2 can also be used in conjunction with a five belt systems of car seats and strollers.

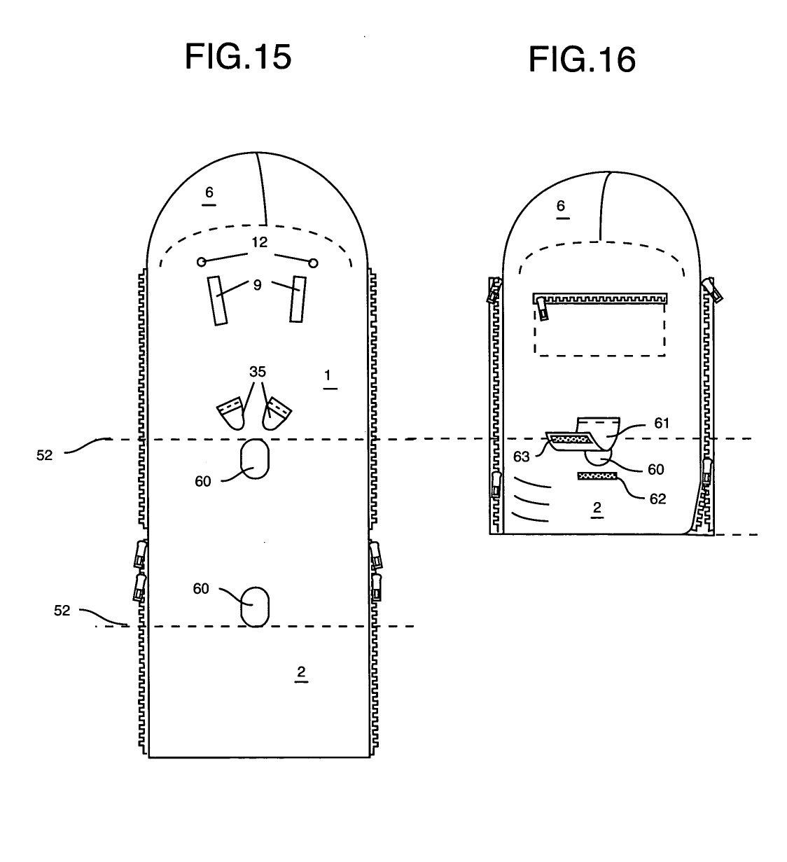

FIG. 15 shows a plan view of the open baby carrier with the body blanket 1 and cover blanket 2 permanently attached as described in FIG. 11 and two holes 60 to feed the center belt of a car seat harness through. FIG. 16 shows the same baby carrier as in FIG. 15 in its closed position showing the hole 60 on the cover blanket which can covered with a flap 61. The flap 61 can be closed tight with a Velcro strip 62 on the cover blanket 2, which attaches to a Velcro strip 63 on the inside of the flap 61.

The embodiments of the invention shown in FIG. 13 through FIG. 16 expand the use of the baby carrier whereby the enclosure formed by the body blanket 1 and the cover blanket 2 can also be used as a cover bag in car seats or strollers.

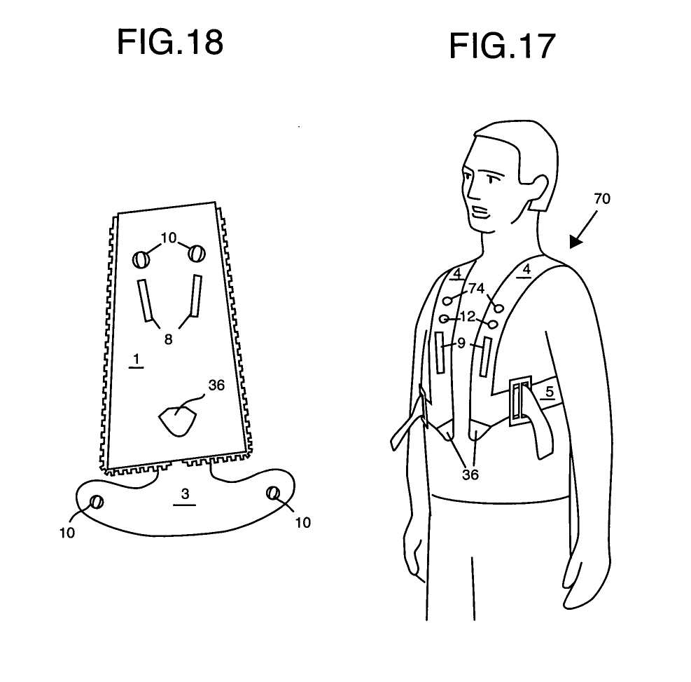

FIG. 17 shows a different harness 70 which features the same mechanism by which the soft seat 3 is attached to the body blanket 1 as describe in FIG. 1 and FIG. 2 namely the inserts 35, the receptacles 9 and the buttons 12. FIG. 18 shows the back of the body blanket 1 to which the harness 70 of FIG. 17 is attached. It features the receptacle 36 and the inserts 8 and the clasps 10, which are the same as on the soft seat 3 as visible in FIG. 1 and FIG. 2.

To have the same attachment method between the soft seat 3 and the harness 70 as between the soft seat 3 and the cover blanket 1 has the several advantages. It allows the body blanket 1 to be left out in the summer and easily installed in-between the soft seat 3 and the harness when needed. Therefore in this embodiment the carrier acts as a conventional carrier without an enclosure system in the summer. But has all the features of this invention when needed in cold or wet weather.

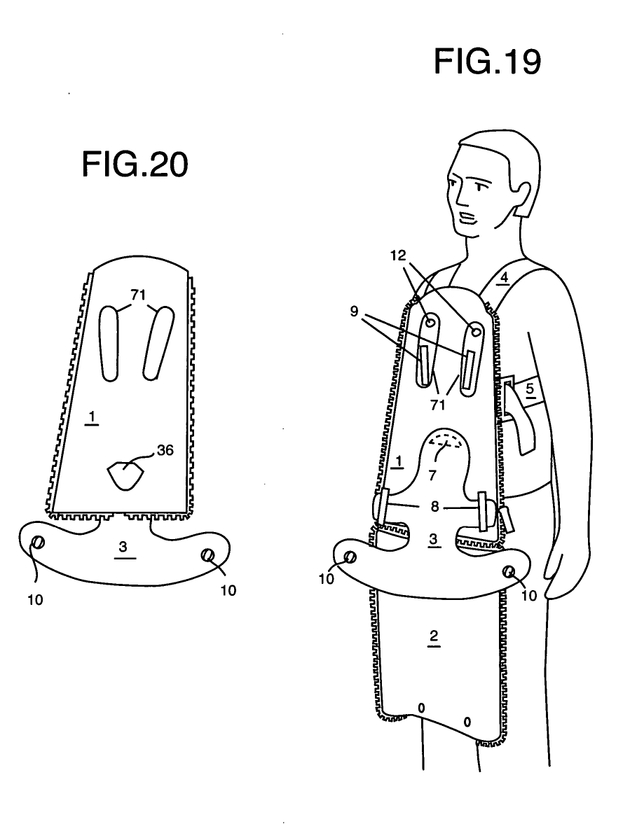

FIG. 19 shows a person wearing the same harness 70 as in FIG. 17 whereby the body blanket 1 has two slots 71 which allow for the pass through of the inserts 8 and clasp 10 and their respective attachment directly to the receptacles 9 and buttons 12 on the harness 70. FIG. 20 shows the back of the body blanket 1 featuring the slots 71 and the receptacle 36.

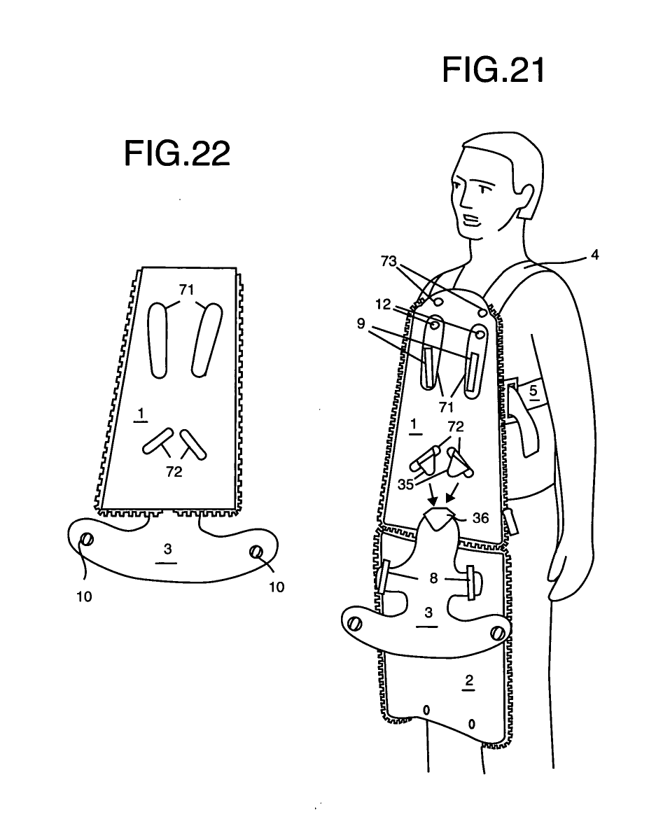

FIG. 21 shows a person wearing the harness 70 whereby the body blanket has the two slots 71 and additional two slots 72, which allow for the pass through of the inserts 35 of the harness 70 and their attachment directly to the receptacle 36 on the soft seat 3. FIG. 22 shows the back of the body blanket 1 with the two pairs of slots 71 and 72. The body blanket 1 features an additional two parts of snaps 73, which can be snapped into the corresponding part of the snaps 74 on the shoulder straps 4 visible on FIG. 17. These snaps consisting of parts 73 and 74 will make it easier to engage insert 8 and clasp 10 of the soft seat 3 through their slots 71 into their corresponding parts 9 and 12 on the harness 70 because it prevents the body blanket 1 from slipping down while the baby is in the soft seat 3.

To have the slots 71 and 72 on the body blanket 1, allowing for the pass through and direct attachment of the soft seat 3 to the harness 70 has the same advantage as described above for FIG. 17 and FIG. 18. It allows the body blanket 1 to be left out in the summer and easily installed when needed.

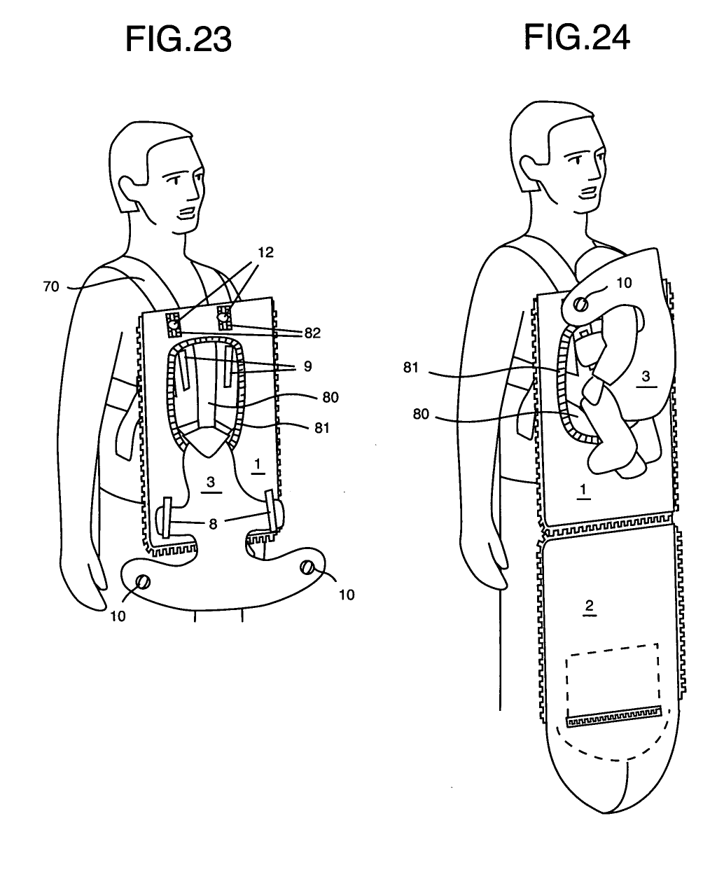

FIG. 23 shows a person wearing a baby carrier with a body blanket 1 that has one large opening 80 for the harness 70 to pass through and attach to the soft seat 3. The seam 81 around the opening is made from a stretchable fabric. Two buttonholes 82 attach the body blanket in this embodiment first to the buttons 12 on the harness 70. When a baby is installed in the soft seat 3 as shown in FIG. 24 the clasp 10 slides over the button 12 as before with the button hole 82 in-between. This alleviates the use of the extra snap parts 73 and 74 as shown in FIG. 17 and FIG. 22.

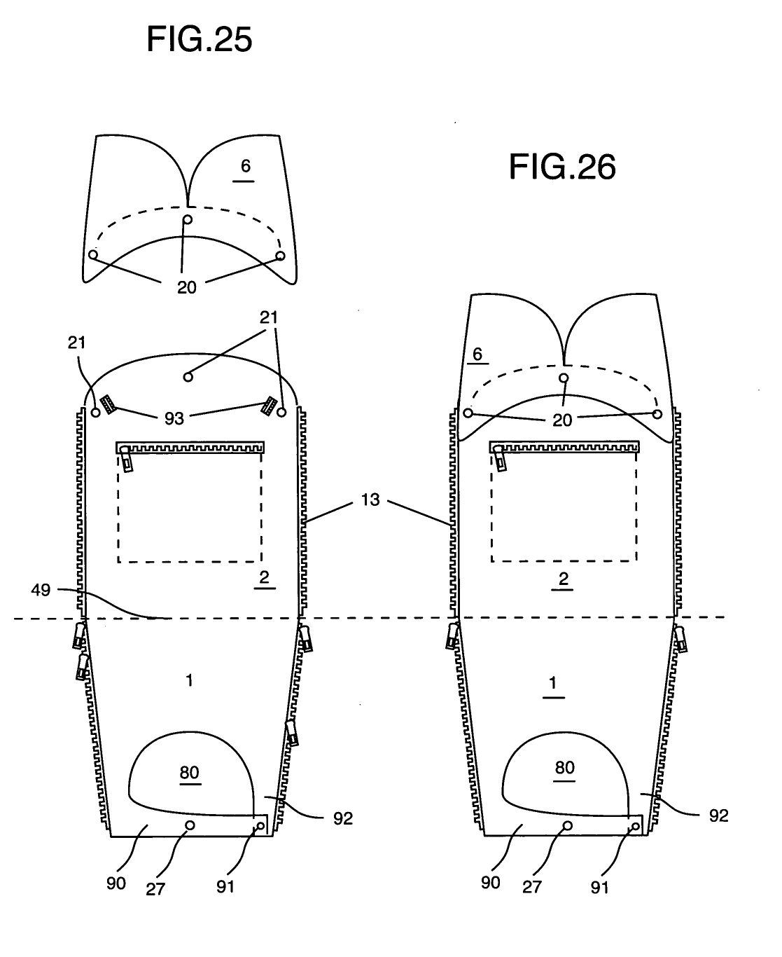

FIG. 25 shows a plan view of a removable body blanket 1 and cover blanket 2 whereby the cover blanket 2 attaches to the harness 70 with a removable hood 6 not attached or as in FIG. 26 attached. In this embodiment of the invention the sequence of attachment is different but all the parts are the same. After the baby is already in the soft seat 3 the cover blanket attaches to the button 12 with a buttonhole 93 or any other attachment method such as snaps etc. The body blanket 1 is pulled between the baby and the adult and the flap 90 is pulled to the opposite top corner 92 of the body blanket 1 and attached by means of a snap 91. This flap 90 when attached forms the same hole 80 around the harness 70 as in FIG. 23 and FIG. 24. In this embodiment of the invention neither the body blanket 1 nor the cover blanket interfere with the harness 70 or the soft seat 3. This makes this embodiment safe and easy to use with all the aforementioned features as temperature control with two-way zippers 13 etc.

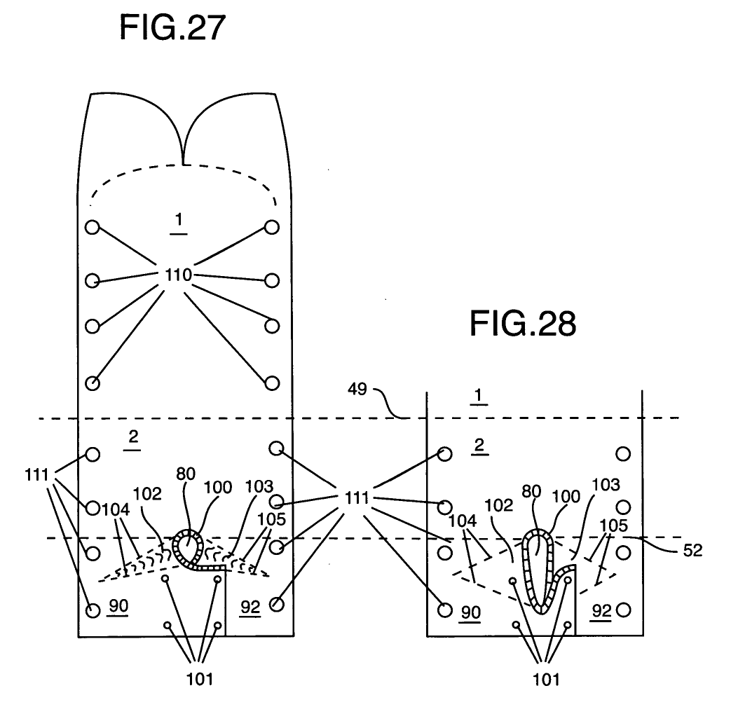

FIG. 27 through FIG. 32 show different ways of creating the hole 80 with the aim of closing in as tight as possible around the harness 70. This is only an aim in the embodiments present in FIG. 23 through FIG. 26.

FIGS. 27 and 28 show an embodiment of the invention with an elastic band 100 sewn into the seam around the opening 80 in body blanket 1. The opening 80 is formed by two overlapping, same size flaps 90 and 92 that are fastened with four snaps 101. The elastic band 100 minimizes the opening 80 by wrapping as tight as possible around the harness 70 and therefore helping to achieve maximum insulation from the cold. FIG. 27 shows the elastic band 64 in its relaxed position and FIG. 28 in its stretched out position. To be able to reach both positions two cuts are made which split the fabric into the edges 104 and 105. Then two triangular piece of fabric 102 and 103 are sewn between the edges 104 and 105 as seen in FIG. 28. When the hole 80 is in its relaxed position the triangular pieces of fabric 102 and 103 will fold up as seen in FIG. 27.

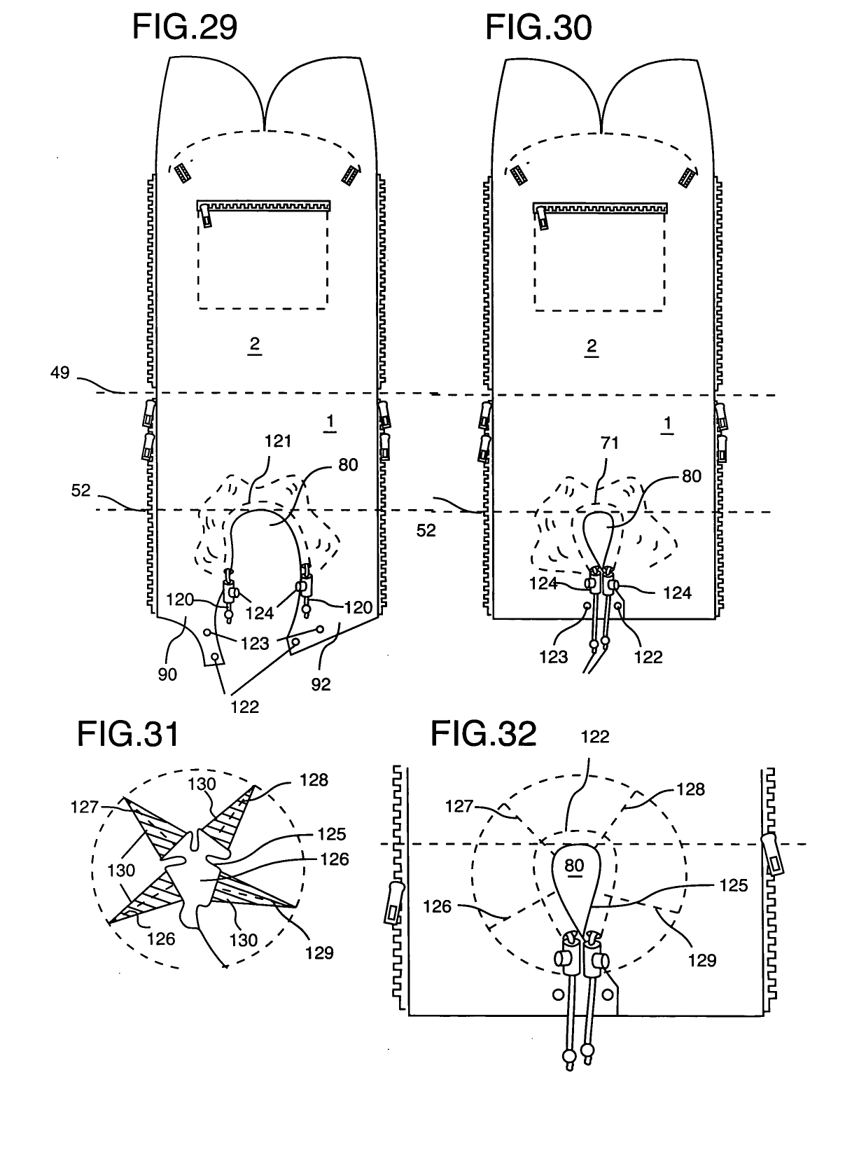

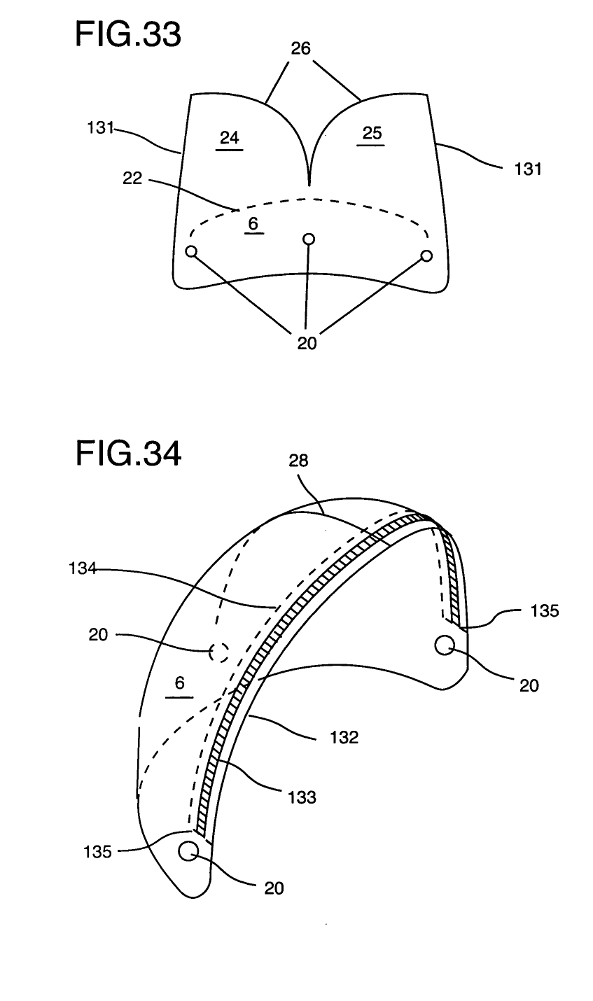

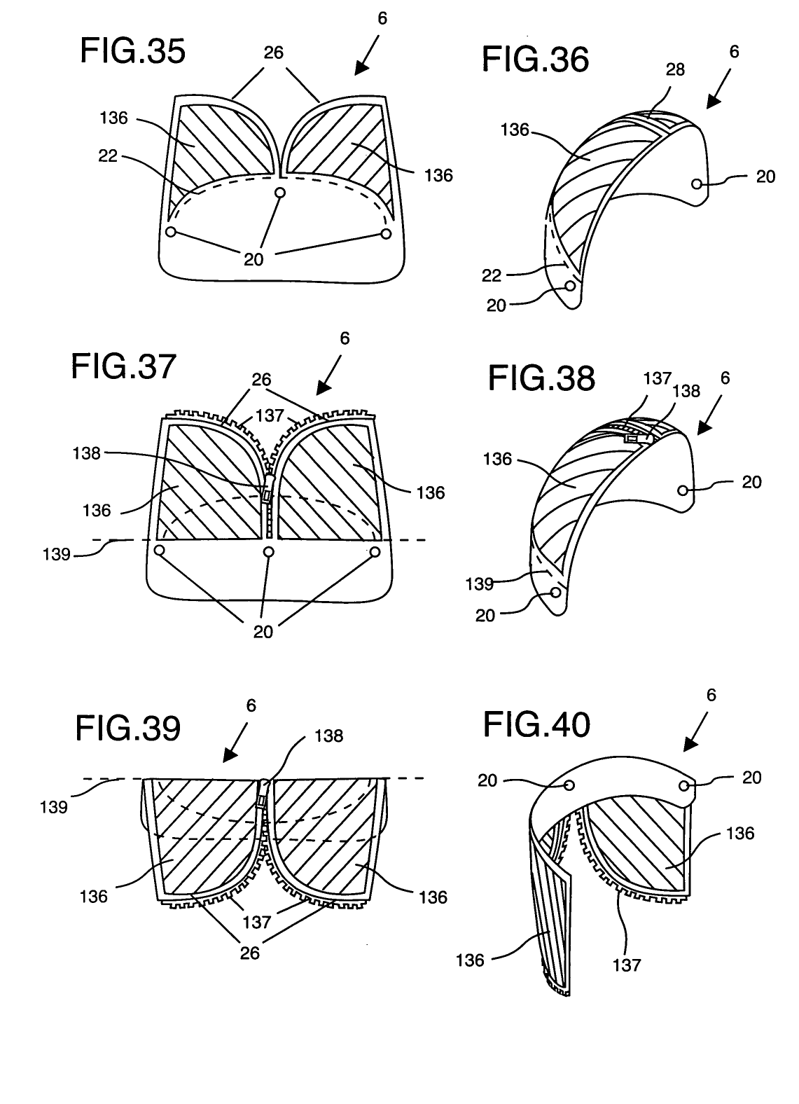

FIGS. 29 through 32 show an embodiment of the invention with elastic string 120 inserted into the seam 121 around the opening 80. Two flaps 90 and 92 that are fastened with 2 pair of snaps 122 and 123 form the opening 80. Pulling at the elastic string 120 and then arresting its tension with two stoppers 124 controls the size of the opening 80. FIG. 29 shows the flaps 90 and 92 not snapped together and the elastic string 120 relaxed, with the two stoppers 124 positioned at the end of the string 120. FIG. 30 shows the hole 80 contracted with the stoppers 124 locking the string 120 in its tightened position. FIG. 31 and FIG. 32 illustrate a way for the opening 80 to be variable. To achieve this, the edge 125 around the opening 80 has to be elongated. For this triangular pieces of fabric 130 are sewn into the cuts 126 through 129. This allows the opening 80 to be of different size and the edge 125 to be arrested at different lengths.

FIG. 33 through FIG. 40 show two different ways to give a hood 6 a shape that will keep it out of the baby's face and therefore will keep it from interfering with the baby's breathing. The embodiments discussed work in the same way for a removable or a hood 6 that is permanently attached to either the cover blanket 2 or the body blanket 1.

FIG. 33 shows a plan view of a removable hood 6 with the sides 131 becoming the arch 132 of the opening of the removable hood 33, as shown in FIG. 34. Without reinforcement the arch 132 would be collapsing onto the baby's face. One way to reinforce this arch 132 Is by inserting a flexible piece of material 133, such as for example boning, into the front seam 134 which runs along this arch 132. When the removable hood 6 is attached to the cover blanket 2 or the body blanket 1 the flexible piece of material 133 will bend up to form the arch 132 because the distance between the two snaps 20 is smaller than the length of the flexible piece of material 133. Two stops 135 are needed as well to give the flexible piece of material 133 something to push against. The two stops can be sewn across the seam 134. The flexible piece of material 133 must have a good balance between its flexibility and its ability to keep the shape of the arch 132. If the flexible piece of material 133 is too rigid the hood 6 will be hard to put on, besides that it wouldn't be pleasing to have a rigid piece inside the hood 6 near the head of the child. If it is too soft the arch 133 will not stay up and the removable hood 6 would fall on the baby's face.

FIG. 35 through FIG. 40 show a flexible mesh 136 layered between the outside fabric and the lining of the hood 6. With this flexible mesh 136 the hood 6 will have enough memory to spring back to its original shape even if the baby pulls at it. In FIG. 11 the hood 6 is sewn along the edges 26 to form the seam 28 as shown in FIG. 36. FIG. 37 through FIG. 40 show a version of the hood 6 with the flexible mesh 136 that is easily folded forward because of a zipper 137 with a tab 138, which is attached along the edges 26. The folding line 139 is located so that the folded hood 6 as shown in FIG. 39 and FIG. 40 clears the upper edge of the soft seat 3. The middle snap of the three snaps 20 has be on the same line as the other two snaps so that the removable hood 6 can be folded along the folding line 139.

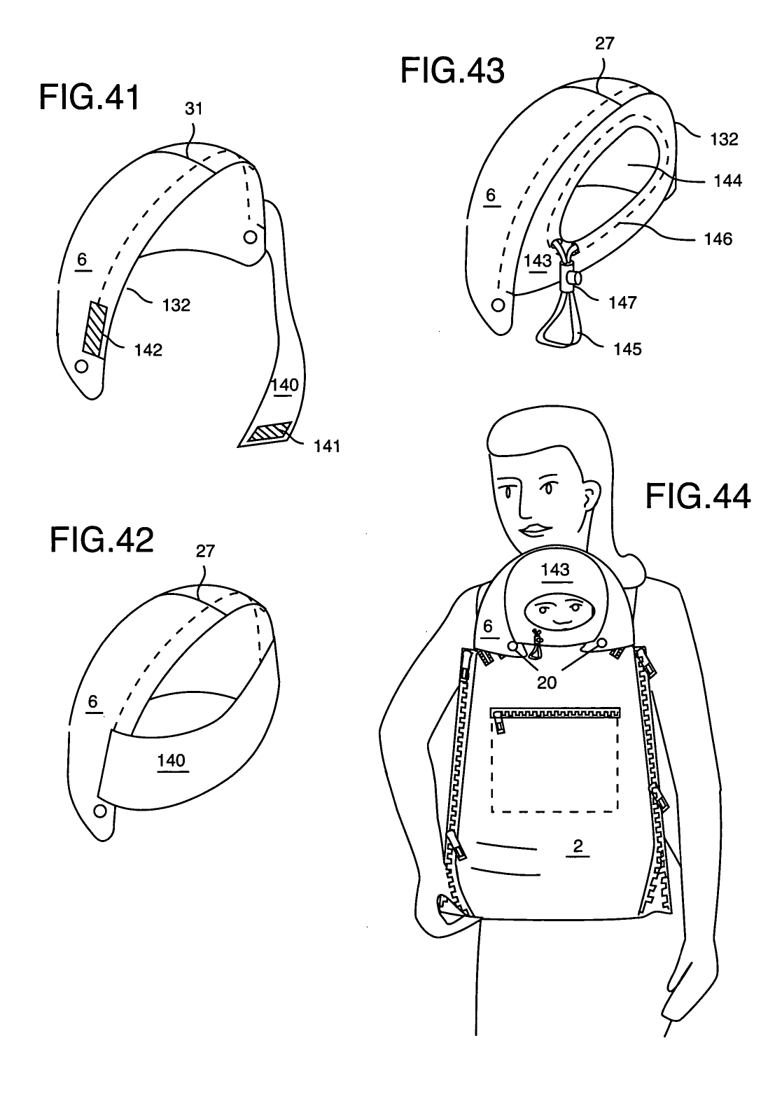

FIGS. 41 through 44 show the hood 6 of FIG. 33 through 40 with various attachments to the front 132 that give extra protection for the baby's face when facing out in the baby carrier as shown in FIG. 44. FIG. 41 shows a protective flap 140 in its open position. As shown in FIG. 42 the protective flap 140 is sewn onto one side of the hood 6 and closes by means of a strip of Velcro 141 on the flap 140 to a strip of Velcro 142 on the hood 6. Any other fastening method than Velcro will not alter the scope of the invention. FIG. 43 shows an alternative way of protecting the baby's face by sewing a continuous cover 143 to the front edge 132 of the hood 6. The cover has an opening 144 that is adjustable with a pull string 145 with a stopper 147 that is sewn into a seam 146 around the opening 144. FIG. 44 shows the hood 6 as described in FIG. 43 attached to a body blanket 1 as described in FIG. 5.

All are made from a pliable fabric such as cotton, denim, nylon or Gore-tex or any natural or synthetic fabric. The material to give the hood shape can vary. The materials used should be within government regulations for the various restrictions that apply to garments and materials to be used for products for infants.

As will be apparent to one skilled in the art, the covering bag of this invention can be modified in a number of ways other than as described in the foregoing and still be within the scope of the appended claims.

1. A baby carrier comprising:
a harness to connect to a person,
a soft seat to hold a baby,
a first garment that fits between the baby and the person, and
a second garment that connects to the first garment around the soft seat on a
side facing away from the person, wherein the first and second garments form an enclosure surrounding the baby with the soft seat.

2. The baby carrier of claim 1, wherein the harness is configured and adapted to attach the baby carrier to the chest of the person.

3. The baby carrier of claim 1, further comprising an attachment mechanism that removably accepts the harness on the side of the first garment that faces the wearer.

4. The baby carrier of claim 1, further comprising an attachment mechanism that removably accepts the soft seat on the side of the first garment facing the baby.

5. The baby carrier of claim 1, further comprising a permanently attached soft seat on the side of the first garment facing the baby.

6. The baby carrier of claim 1, wherein the enclosure has two edges along each side from the baby's shoulders to below its feet and a bottom edge that runs below the baby's feet connecting the two sides whereby the first and second garment meet at these edges.

7. The baby carrier of claim 6, wherein the first and second garments are attached along the sides and along the bottom edge.

8. The baby carrier of claim 7, wherein the first and second garment are attached using a zipper.

9. The baby carrier of claim 7, wherein the first and second garment are attached using buttons.

10. The baby carrier of claim 7, wherein the first and second garment are attached using Velcro.

11. The baby carrier of claim 7, wherein the first and second garment may be opened slightly to allow for temperature control.

12. The baby carrier of claim 7, wherein the attachment mechanism on the first garment can be tugged away along its edges.

13. The baby carrier of claim 1, wherein the first garment has a top edge that extends above the face of the baby in order to protect the person's clothes.

14. The baby carrier of claim 1, wherein the first garment has a top edge that extends above the face of the baby in order to protect the baby from anything sharp or rough on the parents clothing.

15. The baby carrier of claim 1 wherein the top edge of the second garment is attached to the top edge of the soft seat.

16. The baby carrier of claim 1, further comprising a hood that covers the baby's head and is attached to the first garment wherein the hood faces away from the person.

17. The baby carrier of claim 1, further comprising a hood that covers the baby's head and is attached to the second garment wherein the hood faces toward the person.

18. The baby carrier of claim 16 or 17 wherein the hood is removable from the baby carrier.

19. The baby carrier of claim 16 or 17 wherein the hood is reinforced to hold a shape that prevents it from falling in the baby's face and interfere with its breathing.

20. The baby carrier of claim 6, wherein the first and second garment are permanently attached along the bottom edge.

21. The baby carrier of claim 20, wherein the second garment can be tugged away.

22. The baby carrier of claim 1, wherein the same attachment mechanism is used for connecting the soft seat to the first garment on one side as is for the harness on the other side of the first garment.

23. The baby carrier of claim 1, wherein the first garment has one opening that allows one fastener of the harness to connect directly to bottom of the soft seat.

24. The baby carrier of claim 1, wherein the first garment has a plurality of openings that allow for all the fasteners of the harness to connect directly to all the fasteners of the soft seat.

25. The baby carrier of claim 1 wherein the second garment has a strap that passes laterally between the chest of the person and the harness to connect the two top corners of the second garment.

26. The baby carrier of claim 25 wherein the opening has an elastic edge that closes tightly around the harness.

27. The baby carrier of claim 25 wherein the opening has a mechanism that allows it to open and close around the harness.

28. The baby carrier of claim 27 wherein the mechanism is a draw string with a stopper.

29. The baby carrier of claim 1 wherein the enclosure has a slot coming up from the center of the bottom edge that extends to just below the soft seat to allow for attachment of the enclosure to a stroller or car seat.

30. The baby carrier of claim 1 wherein the first and second garments have a plurality of openings to allow the passing through of seat belts.

31. The baby carrier of claim 1 wherein the second garment further comprises a pouch.

32. A baby carrier comprising:
a harness to connect to a person,
a soft seat connected to the harness to hold a baby,
a body blanket connected to the soft seat that fits between the baby and the person, and
a cover blanket connected to the body blanket, wherein the cover blanket and the body blanket form an enclosure.

33. The baby carrier of claim 32 wherein the cover blanket comprises a hood that covers the baby's head.

34. The baby carrier of claim 33 wherein the hood is reinforced.
